(19) United States
(12) Patent Application Publication
(10) Pub. No.: US 2004/0007448 A1
(43) Pub. Date: Jan. 15, 2004

(54) Module for a modular conveyor belt having antimicrobial characteristics and method of manufacture

(76) Inventors: Luis Cediel, Wollerau (CH); Claudia Susanne Honold, Basel (CH)

Correspondence Address: Kevin D. McCarthy, Hodgson Russ LLP, Suite 2000, One M&T Plaza, Buffalo, NY, 14203-2391, US

(21) Appl. No.: 10/194,781

(22) Filed: Jul. 12, 2002

(51) Int. Cl. B65G 17/06

(52) U.S. Cl. 198/851

(57) ABSTRACT

The present invention relates to a modular conveyor belt formed of a plurality of interconnected modules with at least one of them having an antimicorbial material associated therewith. This provides the belt being resistant to growth of fungus, yeast, viruses, and Gram-positive and Gram-negative bacteria including Staph, E coli Klebsiella and Salmonella.

### BACKGROUND OF THE INVENTION

1. Field of the Invention

The present invention relates to beltings and, more particularly, to a module for a modular conveyor belt. The module preferably includes a broad spectrum antimicrobial material associated therewith to inhibit bacterial growth and promote asepsis on the belting.

2. Prior Art

Modular conveyor belting is well-know. For quality control purposes in the food industry, it is desirable that the conveyor belt is readily inspected to assure cleanliness. Government and industry regulations also specify standards of inspection and cleanliness for equipment used in processing products for human consumption. There is, therefore, a need for a conveyor belt having associated therewith an antimicrobial material that inhibits bacterial growth and promotes asepsis on the belting through extended wear, and that is safe for human contact. The antimicrobial material needs to be free of carcinogenic substances and any agents that are both harmful to the environment and are not suitable for human ingestion. As will be explained in detail presently, the conveyor belting of the present invention having the antimicrobial material associated therewith meets these criteria.

### SUMMARY OF THE INVENTION

The present invention relates to a modular conveyor belting having antimicrobial characteristics that inhibit bacterial growth and promote asepsis on the belting, which comprises: a plurality of like modules, each module comprised of a polymeric material and including a first plurality of link ends, a second plurality of link ends and an intermediate section integrally formed with and joining the first and second plurality of link ends, wherein the link ends of each of the modules are releasably engaged between link ends of an adjacent module except for individual link ends disposed at the extreme sides of the module; a pivot rod for pivotally connecting the modules at engaged link ends, wherein the link ends of each of the modules are of a width somewhat less than the spacing between confronting link ends along the pivotal axis thereof to provide for pivotal connection of the modules; and an antimicrobial material associated with the modules, wherein the antimicrobial material is selected from the group consisting of Ca(OH)₂, MgO, ZnO, Al₂O₃, CuO, silver, zinc pyrithione, methyl-N-(2-benzimidazoloyl)carbamat, N-butylbenso-thiazolinone, 10′10-oxybisphenoxyarsin, tebuconazole, imidazole, silver-sodium hydrogen zirconium phosphate, and mixtures thereof provided as a topical applicant to an exposed surface of the module or incorporated into the polymeric material thereof.

Further, the present invention relates to a method for manufacturing a modular conveyor belt having antimicrobial characteristics that inhibit bacterial growth and promote asepsis on the belting, which comprises: providing a plurality of like modules, each comprising a polymeric material and including a first plurality of link ends, a second plurality of link ends and an intermediate section integrally formed with and joining the first and second plurality of link ends, wherein the link ends of each of the modules are releasably engaged between link ends of an adjacent module except for individual link ends disposed at the extreme sides of the module; providing a pivot rod for pivotally connecting the modules at engaged link ends, wherein the link ends of each of the modules are of a width somewhat less than the spacing between confronting link ends along the pivotal axis thereof to provide for pivotal connection of the modules; and associating an antimicrobial material selected from the group consisting of Ca(OH)₂, MgO, ZnO, Al₂O₃, CuO, silver, zinc pyrithione, methyl-N-(2-benzimidazoloyl)-carbamat, N-butylbenso-thiazolinone, 10′10-oxybisphenoxyarsin, tebuconazole, imidazole, silver-sodium hydrogen zirconium phosphate, and mixtures thereof with the modules as a topical applicant to an exposed surface thereof or incorporated into the polymeric material thereof.

Thus, it is within the scope of the present invention that a modular conveyor belt is formed of a plurality of interconnected modules with at least one of them having an antimicorbial material associated therewith. This provides the belt being resistant to growth of fungus, yeast, viruses, and Gram-positive and Gram-negative bacteria including Staph, E coli Klebsiella and Salmonella. The preferred method of associating the antimicrobial material with the modules is to incorporate it into the synthetic polymeric master batch prior to forming them. In that respect, the antimicrobial material in powder form is added as a component to the mixture comprising the synthetic polymeric material and preferably comprises, by weight, from about 0.05% to about 10.0%, and preferably from about 0.1% to about 5.0%, and more preferably from about 0.5% to about 2.0% of the synthetic polymer into which it is incorporated. The resulting synthetic polymeric admixture is injection molded or formed by another molding process to provide modules of various shaped and functions including radius modules, flat top modules, flush grid modules, raised rib modules and flight modules.

It is within the scope of the present invention that other components of a modular belt including the pivot rods, sprockets, fingerboards and side guards are provided with the present antimicrobial materials to inhibit bacterial growth and promote asepsis thereon.

The antimicrobial materials incorporated into a belting components according to the present invention can withstand temperatures of up to about 350° F. without losing its biocidal and biostatic properties.

These and other aspects of the present invention will become more apparent to those of ordinary skill in the art by reference to the following description and to the appended drawings.

### BRIEF DESCRIPTION OF THE DRAWINGS

FIG. 1 is a plan view of a modular conveyor belt 12 constructed of a plurality of interconnected radius modules 10 having an antimicrobial material associated therewith according to the present invention.

FIG. 2 is an upside down, side elevational view of the modular conveyor belt 12 shown in FIG. 1.

FIG. 3 is a perspective view of the module 10 comprising the conveyor belt 12 shown in FIG. 1.

FIG. 4 is an upside down perspective view of the module 10 shown in FIG. 3.

FIG. 5 is a cross-sectional view of an exemplary flat top module 100 constructed having a core 102 completely surrounded by a skin 104 having an antimicrobial material associated therewith according to another embodiment of the present invention.

FIG. 6 is a plan view of the flat top module 100 shown in FIG. 5.

### DETAILED DESCRIPTION OF THE INVENTION

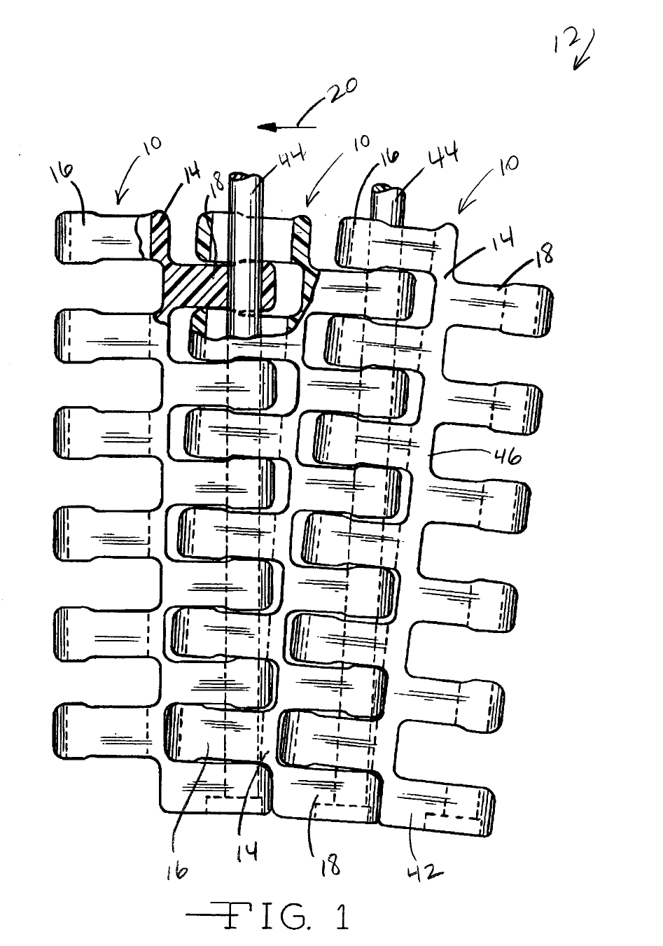

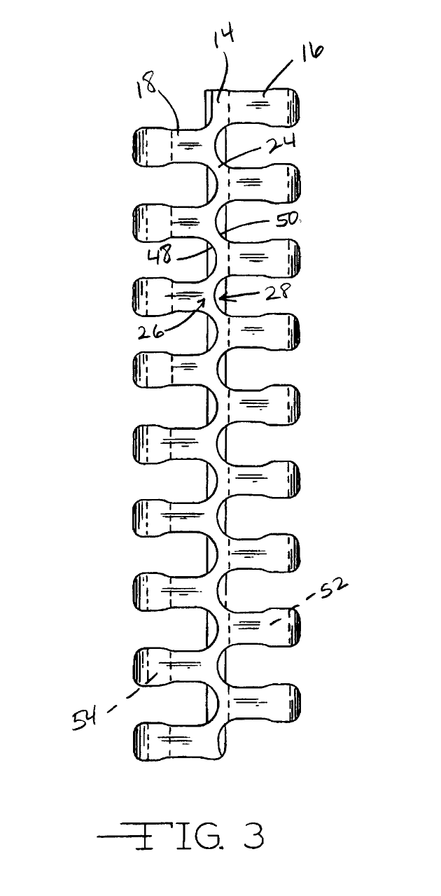

Referring now to the drawings, FIGS. 1 to 4 show an exemplary radius module 10 according to one embodiment of the present invention. The radius module 10 preferably includes a broad spectrum antimicrobial material associated therewith to inhibit bacterial growth and promote asepsis thereon. In use, a plurality of modules 10 are interconnected together to form a modular linked conveyor belt 12 which may be conveyed in either direction and which is particularly suited for traveling along both straight and curved paths.

Each module 10 is an integral unitary structure of polymeric material formed in an injection molding or other molding process and preferably having the antimicrobial material associated therewith. The antimicrobial material is selected from the group consisting of Ca(OH)2, MgO, ZnO, Al₂O₃, CuO, silver, zinc pyrithione, methyl-N-(2-benzimidazoloyl)-carbamat, N-butylbenso-thiazolinone, 10′10-oxybisphenoxyarsin, tebuconazole, imidazole, silver-sodium hydrogen zirconium phosphate, and mixtures thereof. Suitable polymeric materials include polyethylene, polypropylene homopolymer or copolymer, POM and ABS. The concentration of the antimicrobial material in the polymeric material preferably varies from about 0.05% to about 10.0%, by weight. Having the antimicrobial material associated with the module means that it is provided as a topical applicant to an exposed surface thereof, or the antimicrobial material is incorporated into the polymeric material master batch prior to the molding process. In the former case, the belt is run through a bath comprising the antimicrobial material or the antimicrobial material is sprayed thereon.

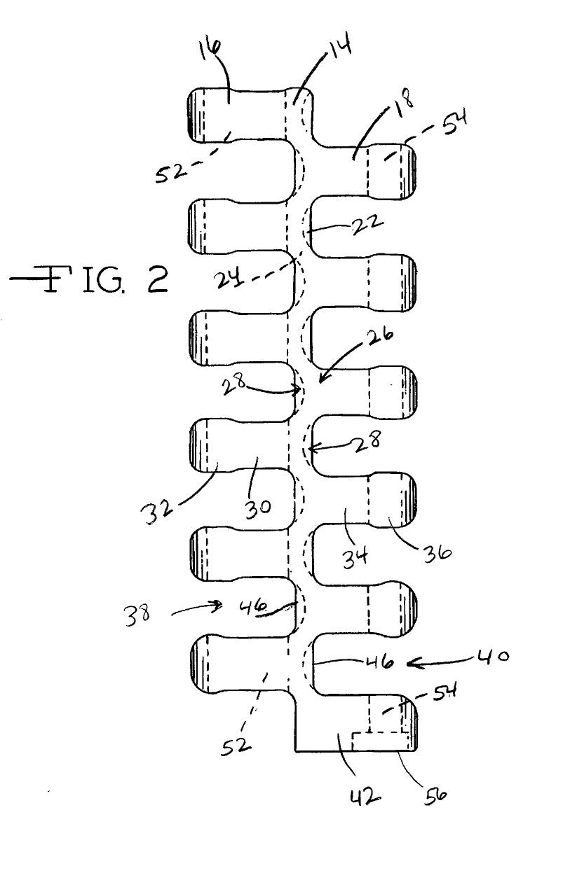

The radius module 10 includes an intermediate section 14 supporting a plurality of first link ends 16 and a plurality of second link ends 18. The first link ends 16 are disposed in the direction of belt travel indicated by arrow 20 and the plurality of second link ends 18 extend in the opposite direction. The intermediate section 14 is comprised of an upper, transverse stiffening web 22 forming into a lower corrugated portion 24. The corrugated portion 24 forms a series of ridges 26 and valleys 28 in a sinusoidal manner. Along with the transverse web 22 of the intermediate section 14, the ridges 26 extending toward the left of FIG. 2 support the first link ends 16 while the ridges 26 extending toward the right in the drawing support the second link ends 18.

The first link ends 16 include a leg portion 30 extending to a distal head portion 32. Likewise, the second link ends 18 include a leg portion 34 extending to a distal head portion 36. An opening 38 is defined between spaced apart leg portions 30 and distal head portions 32 of adjacent first link ends 16. Similarly, an opening 40 is defined between spaced apart leg portions 34 and head portions 36 of adjacent second link ends 18. The openings 38 and 40 terminate in the multilevel surface defined by the web 22 and corrugated portion 24 of the intermediate section 14.

In that respect, the second link ends 18 have the same overall shape as the first link ends 16 (except for the last link end 42) and are designed to fit into the openings 38 between the first link ends 16 such that adjacent belt modules can be intercalated and pivotally connected by pivot rods 44. Similarly, the first link ends 16 are shaped to fit into the openings 40 between the second link ends 18 to provide for intercalation of pivotally connected modules 10. The pivot rods are typically made of a similar or of a compatible polymeric material as that comprising the modules.

The top level of the multi-level intermediate section 14 (best shown in FIG. 1) is defined by a wall 46 of the web 22. The corners where the side walls of the respective first and second link ends 16, 18 meet the web wall 46 are radiused to be smooth and to protect the conveyed product from damage. The relatively thin corrugated portion 24 has a pair of essentially parallel side walls 48, 50 forming the regularly spaced alternating ridges 26 and valleys 28 of the intermediate section 14.

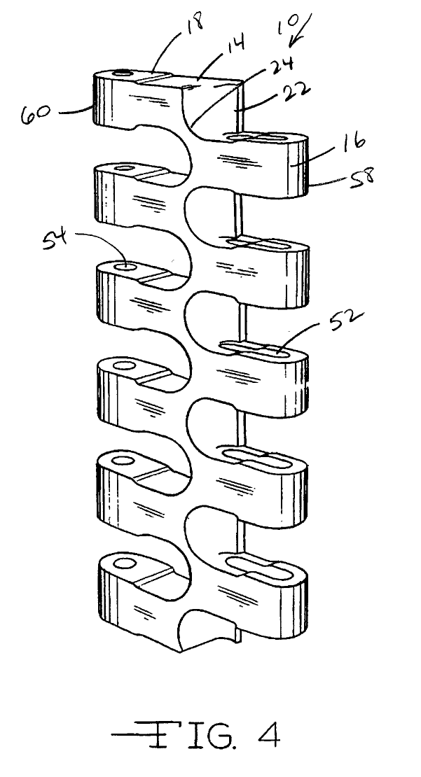

As shown in FIG. 4, the first link ends 16 each include a slot 52 disposed there through transverse to the direction of belt travel. The slot 52 extends in the direction of belt travel such that it is generally oblong and receives the pivot rod 44. The second link ends each have a transverse opening 54 disposed there through. In that manner, the pivot rod 44 passes through the slots 52 in the first link ends 16 and through the openings 54 in the second link ends 16 of intercalated modules forming the belt 12 (FIG. 1). The openings 54 correspond to the shape of the pivot rod 44 so that, in contrast to the slots 52, the pivot rod 44 preferably cannot move in the direction of belt travel inside them. However, due to the oblong shape of the slots 52, the pivot rod 44 pivots inside them such that the intercalated modules are capable of collapsing on one side of the belt while the other side fans out due to the nesting of the link ends 16, 18 and cooperating spaces in the adjacent belt modules.

The last link end 42 of the belt module 10 includes a second opening 56 disposed around opening 54 to provide for countersinking a head (not shown) at the end of the pivot rod 44.

The heads 32 and 36 of the respective first and second link ends 16, 18 are radiused in a smooth rounded surfaces 58, 60. The rounded surfaces 58, 60 preferably have a constant radius and provide a driving surface for engagement with a drive sprocket (not shown), as described in U.S. Pat. No. 6,330,941 to Guldenfels, which is assigned to the assignee of the present invention and incorporated herein by reference.

Also, the rounded surfaces 58, 60 of the link ends 16, 18 enables them to extend under the web 22 into the space defined by the corrugated portion 24. In this manner, the web 22 partially hoods the link ends when the belt 12 collapses. Accordingly, the belt module 10 has the web 22 for structural stability while the corrugated portion 24 provides recesses for collapsing the belt modules along a curved path of a relatively tight radius.

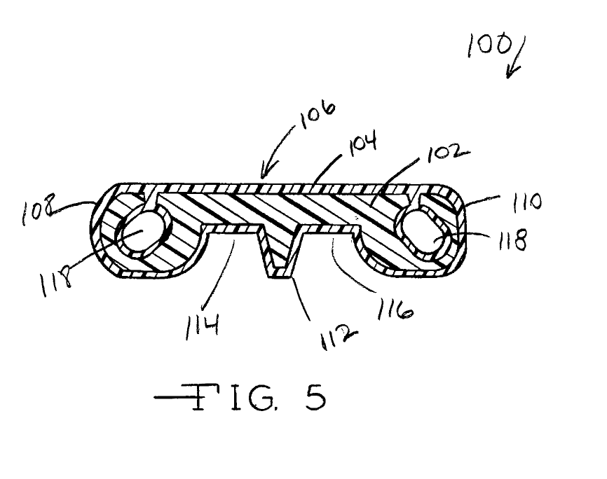

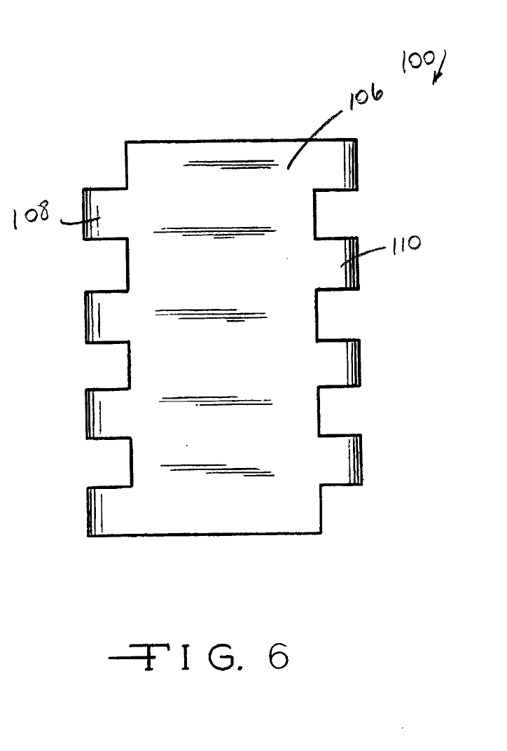

FIGS. 5 and 6 show another embodiment of a module constructed according to the present invention. This module is referred to as a flat top module 100 and also has an antimicrobial material associated therewith. The flat top module 100 has a sandwich layer construction comprising a core portion 102 surrounded and substantially encased by a skin portion 104. Preferably, the polymeric material comprising the skin portion 104 contains an antimicrobial material selected from the group consisting of Ca(OH)₂, MgO, ZnO, Al₂O₃, CuO, silver, zinc pyrithione, methyl-N-(2-benzimidazoloyl)-carbamat, N-butylbenso-thiazolinone, 10′10-oxybisphenoxyarsin, tebuconazole, imidazole, silver-sodium hydrogen zirconium phosphate, and mixtures thereof. The concentration of the antimicrobial material in the polymeric material of the skin portion 104 preferably varies from about 0.05% to about 10.0%, by weight. The polymeric material of the core portion 102 preferably contains little if any of the antimicrobial material. If the core portion 102 does contain antimicrobial material, its concentration is preferably less than that of the skin portion 104. Otherwise, the polymeric materials for the core and skin portions can be the same or different. Suitable polymeric materials include polyethylene, polypropylene homopolymer or copolymer, POM and ABS. The sandwich layer construction is preferably provided by a molding process or method, as described in U.S. application Ser. No. 09/867,122, filed May 29, 2001, which is assigned to the assignee of the present invention and incorporated herein by reference.

In that respect, the sandwich constructed flat top module 100 includes a generally rectangular plate-like body 106 having a first plurality of link ends 108 and a second plurality of link ends 110 extending in opposite directions therefrom. A transverse rib 112 extends across the width of the underside of the body 106 to form opposed channels 114 and 116 terminating at the respective link ends 108 and 110. The rib 112 and the inside of the link ends 108, 110 are adapted to mate with corresponding sprocket teeth of a sprocket wheel (not shown) to impart a driving force to a conveyor belt formed by interconnecting a plurality of the modules 100 in a similar manner as previously described with respect to the radius module 10 and its belt 12. The under structure of the module 100 formed by the transverse rib 112 serves to strengthen the module and prevent any significant binding about its longitudinal or transverse axis.

The link ends 108 and 110 circumscribe corresponding aligned cylindrically shaped transverse openings 118. The openings 118 receive pivot rods (not shown) adapted to pivotally connect a plurality of the modules in an end to end configuration to form a modular conveyor belt (not shown) similar to the conveyor belt 12 shown in FIGS. 1 and 2. Preferably, the modules 100 are end-to-end reversible so that either end of a first module can mate with either end of a second module.

While the present invention has been particularly described with respect to a radius module and a flat top module, it is not intended to be so limited. Those skilled in the art will recognize that the present antimicrobial materials are readily incorporable into other types of modules and belt components. These include the modules described in U.S. Pat. No. 6,305,530 to Guldenfels, U.S. Pat. No. 6,357,581 to Guldenfels and U.S. Pat. No. 6,382,404 to Guldenfels, all of which are assigned to the assignee of the present invention and incorporated herein by reference. A raised rib module is shown in U.S. Pat. No. 5,850,902 to Hicks et al.

It is intended that the foregoing description be only illustrative of the present invention and that the present invention be only limited by the hereinafter appended claims.

What is claimed is:

1. A modular conveyor belting having antimicrobial characteristics that inhibit bacterial growth and promote asepsis on the belting, which comprises:
a) plurality of modules, each comprised of a polymeric material and including a first plurality of link ends, a second plurality of link ends and an intermediate section integrally formed with and joining the first and second plurality of link ends, wherein the link ends of each of the modules are releasably engaged between link ends of an adjacent module except for individual link ends disposed at the extreme sides of the module;
b) a pivot rod for pivotally connecting the modules at engaged link ends, wherein the link ends of each of the modules are of a width somewhat less than the spacing between confronting link ends along the pivotal axis thereof to provide for pivotal connection of the modules; and
c) an antimicrobial material associated with at least one of the modules, wherein the antimicrobial material is selected from the group consisting of Ca(OH)₂, MgO, ZnO, Al₂O₃, CuO, silver, zinc pyrithione, methyl-N-(2-benzimidazoloyl)-carbamat, N-butylbenso-thiazolinone, 10′10-oxybisphenoxyarsin, tebuconazole, imidazole, silver-sodium hydrogen zirconium phosphate, and mixtures thereof.

2. The conveyor belting of claim 1 wherein the antimicrobial material is associated with the module as a topical applicant applied to an exposed surface thereof or incorporated into the polymeric material thereof.

3. The conveyor belting of claim 1 wherein the antimicrobial material is present in the polymeric material in an amount of about 0.05% to about 10.0%, by weight.

4. The conveyor belting of claim 1 wherein the plurality of first link ends and second link ends of each module are provided with an opening aligned along respective first and second pivot axes for receiving the pivot rod for pivotally connecting the modules at the engaged link ends.

5. The conveyor belting of claim 1 wherein the module is selected from the group consisting of a flat top module, a radius module, a flush grid module, a raised rib module and a flight module.

6. The conveyor belting of claim 1 wherein the at least one module is of a polymeric material which is substantially uniform in its composition throughout the module.

7. The conveyor belting of claim 1 wherein the at least one module comprises a first polymeric skin material substantially encasing a second core polymeric material.

8. The conveyor belting of claim 7 wherein the concentration of the antimicrobial material in the first polymeric skin material is greater than in the second core polymeric material.

9. A method of manufacturing a modular conveyor belting having antimicrobial characteristics that inhibit bacterial growth and promote asepsis on the belting, which comprises:
a) providing a plurality of modules, each comprising a polymeric material and including a first plurality of link ends, a second plurality of link ends and an intermediate section integrally formed with and joining the first and second plurality of link ends, wherein the link ends of each of the modules are releasably engaged between link ends of an adjacent module except for individual link ends disposed at the extreme sides of the module;
b) providing a pivot rod for pivotally connecting the modules at engaged link ends, wherein the link ends of each of the modules are of a width somewhat less than the spacing between confronting link ends along the pivotal axis thereof to provide for pivotal connection of the modules; and
c) associating an antimicrobial material with at least one of the modules, wherein the antimicrobial material is selected from the group consisting of Ca(OH)₂, MgO, ZnO, Al₂O₃, CuO, silver, zinc pyrithione, methyl-N-(2-benzimidazoloyl)-carbamat, N-butylbenso-thiazolinone, 10′10-oxybisphenoxyarsin, tebuconazole, imidazole, silver-sodium hydrogen zirconium phosphate, and mixtures thereof.

10. The method of claim 9 including providing the antimicrobial material as a topical applicant to an exposed surface of the module or incorporating it into the polymeric material thereof.

11. The method of claim 9 wherein the antimicrobial material is present in the polymeric material in an amount of about 0.05% to about 10.0%, by weight.

12. The method of claim 9 including selecting the module from the group consisting of a flat top module, a radius module, a flush grid module, a raised rib module and a flight module.

13. The method of claim 9 including providing the at least one module being of a polymeric material which is substantially uniform in its composition throughout the module.

14. The method of claim 13 including providing the at least one module of a first polymeric skin material substantially encasing a second core polymeric material.

15. The method of claim 14 wherein the concentration of the antimicrobial material in the first polymeric skin material is greater than in the second core polymeric material.

16. A modular conveyor belting, which comprises:
a) a plurality of like modules, each module comprised of a polymeric material and including a first plurality of link ends, a second plurality of link ends and an intermediate section integrally formed with and joining the first and second plurality of link ends, wherein the link ends of each of the modules are releasably engaged between link ends of an adjacent module except for individual link ends disposed at the extreme sides of the module and wherein the polymeric material comprising the module is in a sandwich layer construction having a first polymeric skin material supported on a second core polymeric material;
b) a pivot rod pivotally connecting the modules at engaged link ends; and
c) an antimicrobial material associated with the polymeric material comprising the module, wherein the antimicrobial material is selected from the group consisting of Ca(OH)₂, MgO, ZnO, Al₂O₃, CuO, silver, zinc pyrithione, methyl-N-(2-benzimidazoloyl)-carbamat, N-butylbenso-thiazolinone, 10′10-oxybisphenoxyarsin, tebuconazole, imidazole, silver-sodium hydrogen zirconium phosphate, and mixtures thereof.

17. The conveyor belting of claim 16 wherein the antimicrobial material is incorporated into the skin polymeric material.

18. The conveyor belting of claim 17 wherein the concentration of the antimicrobial material in the skin polymeric material is greater than its concentration in the core polymeric material.

19. The conveyor belting of claim 16 wherein the antimicrobial material is present in the polymeric material in an amount of about 0.05% to about 10.0%, by weight.

20. The conveyor belting of claim 16 wherein the modules are selected from the group consisting of flat top modules, radius modules, flush grid modules, raised rib modules, and flight modules.

21. A method for manufacturing a modular conveyor belt, comprising the steps of:
a) providing a plurality of like modules, each comprising a polymeric material and including a first plurality of link ends, a second plurality of link ends and an intermediate section integrally formed with and joining the first and second plurality of link ends, wherein the link ends of each of the modules are releasably engaged between link ends of an adjacent module except for individual link ends disposed at the extreme sides of the module and wherein the polymeric material comprising the module is in a sandwich layer construction having a first polymeric skin material supported on a second core polymeric material;
b) providing a pivot rod pivotally connecting the modules at engaged link ends; and
c) an antimicrobial material associated with the polymeric material comprising the module and selecting the antimicrobial material from group consisting of Ca(OH)₂, MgO, ZnO, Al₂O₃, CuO, silver, zinc pyrithione, methyl-N-(2-benzimidazoloyl)-carbamat, N-butylbenso-thiazolinone, 10′10-oxybisphenoxyarsin, tebuconazole, imidazole, silver-sodium hydrogen zirconium phosphate, and mixtures thereof.

21. The method of claim 20 including providing a first concentration of the antimicrobial material in the skin polymeric material being greater than a second concentration of the antimicrobial material in the core polymeric material.

21. The method of claim 21 including providing the first concentration of the additive material in an amount of about 0.05% to about 10.0%, by weight.
